(19) United States
(12) Patent Application Publication
(10) Pub. No.: US 2026/0287033 A1
(43) Pub. Date: Sep. 24, 2026

(54) BRAKE CALIPER FOR A DISC BRAKE

(71) Applicant: Brembo S.p.A., Curno, Bergamo (IT)

(72) Inventor: Alessandro BERTAGNA, Curno, Bergamo (IT)

(21) Appl. No.: 19/472,344

(22) PCT Filed: Apr. 3, 2024
(86) PCT No.: PCT/IB2024/053227

§ 371 Date: Oct. 3, 2025

(30) Foreign Application Priority Data
Apr. 6, 2023 (IT) 102023000006795

(51) Int. Cl. F16D 55/228; F16D 55/00; F16D 65/18; F16D 121/24; F16D 125/40; F16D 125/48

(52) U.S. Cl. CPC F16D 55/228; F16D 65/18; F16D 2055/0016; F16D 2121/24; F16D 2125/40; F16D 2125/48

(57) ABSTRACT

A brake caliper (1) for a disc brake (2), comprising a housing body (3) adapted to be arranged straddling a brake disc (4), said brake caliper (1) comprising a first pad (5) and a second opposite pad (6) connected to the housing body (3), wherein the first pad (5) and the second pad (6) are spaced apart and delimit a disc space to accommodate a brake disc (4), wherein the brake caliper (1) comprises an electric motor (8) and a transmission system (9), and wherein the transmission system (9) is configured to transmit a mechanical power generated by the electric motor (8) to the first pad (5) and the second pad (6), wherein the transmission system (9) comprises a first actuation device (10) and a second actuation device (11), wherein the first actuation device (10) is placed at the first pad (5), and it is configured to actuate the first pad (5) approaching to or receding from the brake disc (4), wherein the second actuation device (11) is placed at the second pad (6), and it is configured to actuate the second pad (6) approaching to or receding from the brake disc (4), wherein the first actuation device (10) comprises a first threaded wall (12) forming a first thread (19), the second actuation device (11) comprises a second threaded wall (33) forming a second thread (21), and wherein the first thread (19) is opposite to the second thread (21).

### FIELD OF THE INVENTION

The present invention relates to a brake caliper for a disc brake, in particular an electromechanical brake caliper, and to a disc brake comprising such a brake caliper.

### BACKGROUND ART

On vehicles, in particular in disc brakes, the brake caliper is arranged straddling the outer peripheral margin of a brake disc. The brake caliper usually comprises a body having two elongated elements, referred to as side portions, which are arranged to face opposite braking surfaces of a disc. Friction pads are provided between each side portion of the caliper and the braking surfaces of the brake disc. At least one of the side portions of the caliper body has cylinders adapted to accommodate pistons, actuated in any suitable known manner (e.g., hydraulic or electro-mechanical pistons), capable of applying a pushing action to the pads, abutting them against the braking surfaces of the disc to apply a braking action to the vehicle.

Brake calipers are usually constrained to a support structure which remains fixed to the vehicle, such as a stub axle of a vehicle suspension, for example.

In a typical arrangement, one of the two side portions has two or more portions for attaching the caliper body to the support structure, for example providing slots or eyelets, e.g., arranged axially, or through holes, e.g., arranged radially, adapted to receive screws for fixing the caliper, which are accommodated with ends thereof in threaded holes provided on the caliper support. Such a side portion is referred to as the attachment side portion or vehicle-side elongated element. The other portion is referred to as the non-attachment side portion or wheel-side elongated elements.

In a typical construction of a caliper body, the side portions facing the braking surfaces of the disc are connected to each other by bridge-like elements arranged straddling the disc, referred to as bridges.

As said, opposite pads in the disc brake calipers are pressed, by virtue of the action of at least one piston, against opposite braking surfaces of a braking band of the associable brake disc.

This piston is usually accommodated in a cylinder obtained in the caliper body and is energized by brake fluid pressurized by a brake pump, usually pedal-operated in motor vehicles and lever-operated in motorcycles.

There are also known brake calipers in which the piston or pistons is or are electro-mechanically energized, for example by the rotation of a recirculating-ball screw accommodated in the piston body and rotated by an electric motor, or more commonly by a ratio motor.

In particular, there are known electromechanical brake calipers in which the actuation system of the piston is located entirely on only one side of the brake caliper, referred to as the action side, opposite to a reaction side.

In such electromechanical brake calipers, the actuation system can control, both under pushing and pulling, only the pad placed on the action side, referred to as the action pad, and not also the opposite pad on the reaction side, referred to as the reaction pad.

Therefore, in such electromechanical brake calipers, the generation of residual torque on the brake disc is known, being produced by the incomplete detachment of the reaction pad from the brake disc because there is no possibility to control the movement of the reaction pad in the direction which allows it to completely detach from the brake disc.

A further criticality of the known electromechanical calipers is caused by the large axial dimensions thereof due to the actuation system which generally comprises a recirculating-ball screw system placed at the action pad.

### SOLUTION

It is the object of the present invention to provide a brake caliper for a disc brake, in particular an electromechanical brake caliper, having features such as to obviate at least some of the drawbacks of the prior art.

It is a particular object of the present invention to provide a brake caliper for a disc brake, in particular an electromechanical brake caliper, in which no residual torque is generated on a brake disc.

It is a further particular object of the present invention to provide a brake caliper for a disc brake, in particular an electromechanical brake caliper, have small axial dimensions.

These and other objects are achieved by a brake caliper for a disc brake according to claim 1.

The dependent claims relate to preferred and advantageous embodiments of the present invention.

### DRAWINGS

In order to better understand the invention and appreciate the advantages thereof, some non-limiting exemplary embodiments thereof will be described below with reference to the accompanying drawings, in which:

FIG. 1 is a diagrammatic axial section view of a brake caliper for a disc brake according to an embodiment of the invention;

FIG. 2 is a diagrammatic axial section view of a brake caliper for a disc brake according to a further embodiment of the invention;

FIG. 3 is a diagrammatic axial section view of a brake caliper for a disc brake according to a further embodiment of the invention;

FIG. 4 is a diagrammatic axial section view of a brake caliper for a disc brake according to a further embodiment of the invention;

FIG. 5 is a diagrammatic axial section view of a brake caliper for a disc brake according to a further embodiment of the invention;

FIG. 6 is a diagrammatic axial section view of a brake caliper for a disc brake according to a further embodiment of the invention;

FIG. 7 is a perspective view of a portion of a brake caliper for a disc brake according to an embodiment of the invention.

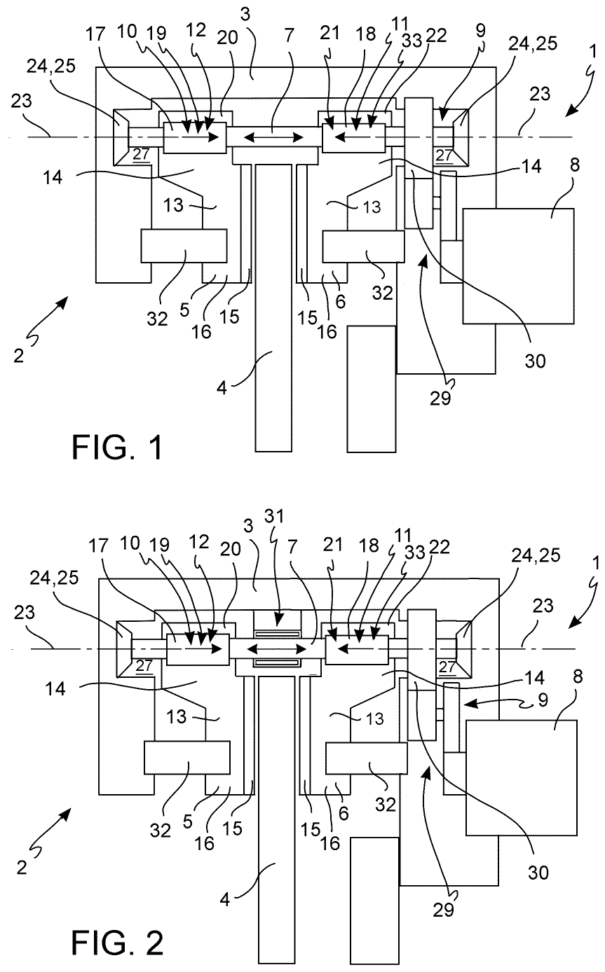

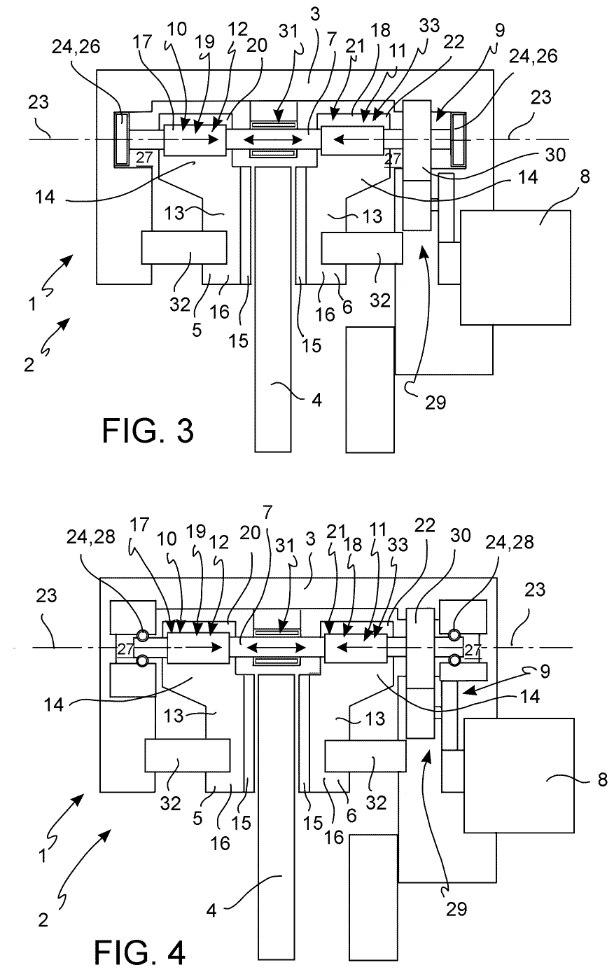

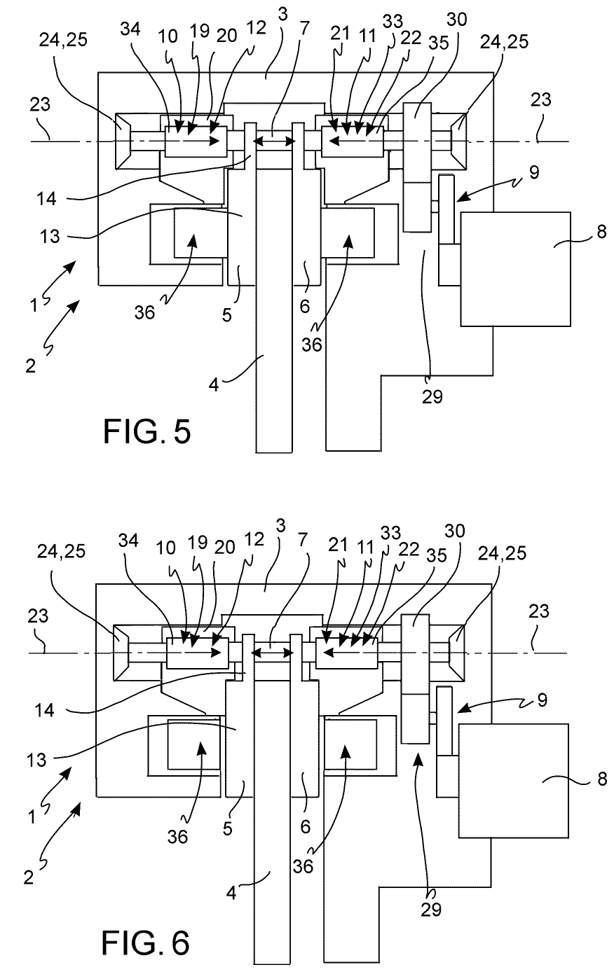

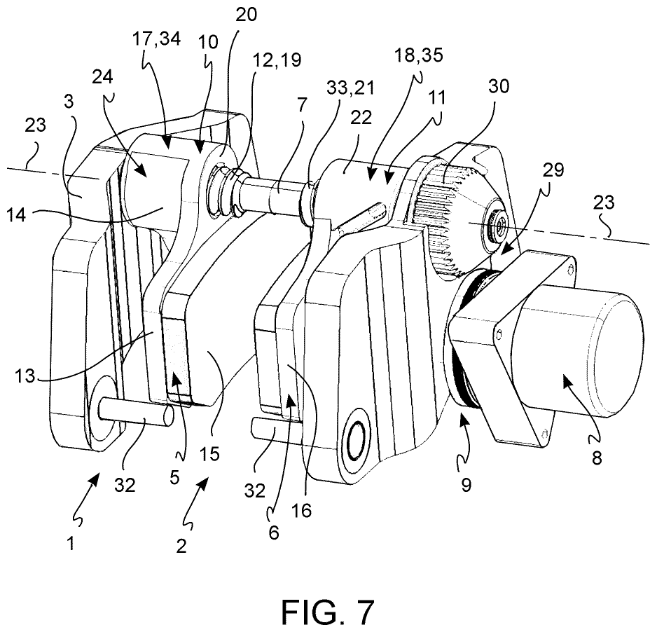

### DESCRIPTION OF SOME PREFERRED EMBODIMENTS

With reference to the figures, brake caliper, in particular an electromechanical brake caliper, is generally indicated by reference numeral 1.

The brake caliper 1 is suited for a disc brake 2.

The brake caliper 1 comprises a housing body 3. The housing body 3 is adapted to be connected to be integral with a stub axle of a vehicle.

The brake caliper 1 comprises a first pad 5 and an opposite second pad 6.

The first pad 5 and the second pad 6 are connected to the housing body 3.

The first pad 5 and the second pad 6 are spaced apart and delimit a disc space to accommodate a brake disc 4.

The brake caliper 1 comprises an electric motor 8 and a transmission system 9.

The transmission system 9 is configured to transmit a mechanical power generated by the electric motor 8 to the first pad 5 and the second pad 6.

The transmission system 9 comprises a first actuation device 10 and a second actuation device 11.

The first actuation device 10 is placed at the first pad 5.

The first actuation device 10 is configured to actuate the first pad 5 approaching to or receding from the brake disc 4.

The second actuation device 11 is placed at the second pad 6.

The second actuation device 11 is configured to actuate the second pad 6 approaching to or receding from the brake disc 4.

According to an aspect of the invention, the first actuation device 10 comprises a first threaded wall 12, which forms a first thread 19.

Moreover, the second actuation 11 comprises a second threaded wall 33, which forms a second thread 21.

Moreover, the first thread 19 is opposite to the second thread 21.

Advantageously, by means of opposite threads 19, 21, i.e., having threading with opposite helix direction, it is possible to move both the first pad 5 and the second pad 6 approaching to and receding from the brake disc 4 by means of the transmission system 9.

According to an embodiment, the first thread 19 is a right-hand thread, and the second thread 21 is a left-hand thread.

Advantageously, by means of the first right-hand thread 19 and the second left-hand thread 21, it is possible to move both the first pad 5 and the second pad 6 approaching to and receding from the brake disc 4 by means of the transmission system 9.

Advantageously, controlling the movement of both pads 5, 6 allows eliminating the residual torque generatable on the brake disc 4, since a complete detachment of the opposite pads 5, 6 from the brake disc 4 can be ensured.

According to an embodiment, the first actuation device 10 is connected to be integral with the first pad 5, and the second actuation device 11 is connected to be integral with the second pad 6.

According to an embodiment, the first actuation device 10 comprises a first nut screw 20.

The second actuation device 11 comprises a second nut screw 22.

According to an embodiment, the first nut screw 20 is connected to be integral with the first pad 5, and the second nut screw 22 is connected to be integral with the second pad 6.

According to an embodiment, the first actuation device 10 comprises a first recirculating-ball screw 17.

The second actuation device 11 comprises a second recirculating-ball screw 18.

According to an embodiment, the first recirculating-ball screw 17 comprises a first nut screw 20 externally connected to the first threaded wall 12.

The second recirculating-ball screw 18 comprises a second nut screw 22 externally connected to the second threaded wall 33.

According to this embodiment, the first recirculating-ball screw 17 has a thread opposite to the thread of the second recirculating-ball screw 18. Specifically, the first recirculating-ball screw 17 has a right-hand thread, and the second recirculating-ball screw 18 has a left-hand thread.

According to an embodiment, both the first recirculating-ball screw 17 and the second recirculating-ball screw 18 have a reversible-type thread.

Advantageously, such a configuration allows a retrograde motion of the first and second pads 5, 6, and thus a cessation of the braking force applied to the brake disc 5, in the absence of an actuation from the electric motor 8.

Such a configuration is particularly advantageous for a service disc brake 2.

According to an embodiment, the first actuation device 10 comprises a first screw-nut screw assembly 34.

The second actuation device 11 comprises a second screw-nut screw assembly 35.

According to an embodiment, the first screw-nut screw assembly 34 comprises a first nut screw 20 externally connected to the first threaded wall 12.

The second screw-nut screw assembly 35 comprises a second nut screw 22 externally connected to the second threaded wall 33.

According to this embodiment, the first screw-nut screw assembly 34 has a thread opposite to the thread of the second screw-nut screw assembly 35. Specifically, the first screw-nut screw assembly 34 has a right-hand thread, and the second screw-nut screw assembly 35 has a left-hand thread.

According to an embodiment, both the first screw-nut screw assembly 34 and the second screw-nut screw assembly 35 have an irreversible-type thread.

Advantageously, such a configuration allows preserving the braking force applied by the first and second pads 5, 6 to the brake disc 4 even in the absence of an actuation from the electric motor 8.

Such a configuration is particularly advantageous for a parking disc brake 2.

According to an embodiment, the transmission device 9 comprises a threaded actuation shaft 7.

According to an embodiment, the actuation shaft 7 comprises the first threaded wall 12 and the second threaded wall 33, which form opposite threads, respectively. Specifically, the actuation shaft 7 comprises the first threaded wall 12 and the second threaded wall 33 which form the first right-hand thread 19 and the second left-hand thread 21, respectively.

According to this embodiment, both the first pad 5 and the second pad 6 are connected to the actuation shaft 7.

The actuation shaft 7 is configured to move both the first pad 5 and the second pad 6 approaching to or receding from the brake disc 4.

Specifically, the first pad 5 is connected to the actuation shaft 7 at the first thread 19, and the second pad 6 is connected to the actuation shaft 7 at the second thread 21.

Advantageously, by means of the first thread 19 opposite to the second thread 21, i.e., preferably by means of the first right-hand thread 19 and the second left-hand thread 21 of the actuation shaft 7, it is possible to move both the first pad 5 and the second pad 6 selectively approaching to or receding from the brake disc 4 by means of a unique movement of the actuation shaft 7. Therefore, such a configuration allows controlling the movement of both pads 5, 6 by a single actuating element represented by the actuating shaft 7.

Specifically, the transmission system 9 is configured so that a rotation of actuation shaft 7 in one direction of rotation corresponds, by means of the first thread 19 opposite to the second thread 21, preferably by means of the first right-hand thread 19 and the second left-hand thread 21, to a movement of both the first pad 5 and the second pad 6 approaching the brake disc 4. Conversely, a rotation of the actuation shaft 7 in the opposite direction of rotation corresponds to a movement of both the first pad 5 and the second pad 6 receding from the brake disc 4. Therefore, by means of the first right-hand thread 19 and the second left-hand thread 21, a rotation of the actuation shaft 7 actuates the first pad 5 and the second pad 6 in translation in the opposite direction. Therefore, the motion of the two pads 5, 6 depends on only one control variable, i.e., the position of the electric motor 8.

Advantageously, such a configuration allows eliminating the residual torque generatable on the brake disc 4, because the actuation shaft 7, by means of the two opposing threads 19, 21, allows controlling the movement of both opposite pads 5, 6 of the brake caliper 1, thus ensuring a complete detachment of the opposite pads 5, 6 from the brake disc 4.

With added advantage, such a configuration of the brake caliper 1 has small axial dimensions because the arrangement of an entire actuation system comprising a recirculating-ball screw system is avoided at only one of the two pads.

According to an embodiment, the first pad 5 and the second pad 6 each comprise a pushing portion 13 and a connecting portion 14.

The pushing portion 13 is placed at the brake disc 4 and comprises a friction material layer 15 facing the brake disc 4, and a support plate 16 which supports the friction material layer 15.

The first pad 5 and the second pad 6 are connected to the transmission system 9 at their own respective connecting portion 14.

According to an embodiment, the first actuation device 10 is placed at the connecting portion 14 of the first pad 5, and the second actuation device 11 is placed at the connecting portion 14 of the second pad 6.

According to an embodiment, the actuation shaft 7 extends along a shaft axis 23.

According to an embodiment, the shaft axis 23 is substantially transverse to the brake disc 4.

Moreover, the shaft axis 23 is substantially transverse to the first pad 5 and the second pad 6. Specifically, the shaft axis 23 is transverse to the friction material layers 15 of the first pad 5 and the second pad 6.

Specifically, the shaft axis 23 is directed in a direction parallel to the rotation axis of the brake disc 4. Moreover, the shaft axis 23 extends along a direction not passing through the brake disc 4.

According to an embodiment, the actuation shaft 7 is connected to the housing body 3 by means of floating connection elements 24.

The floating connection elements 24 are configured to allow for a relative translation between the actuation shaft 7 and the housing body 3 in the direction of the shaft axis 23.

Advantageously, the floating connection elements 24 allow both pads 5, 6 to abut against the brake disc 4 if one of the two pads 5, 6 abuts against the brake disc 4 before the other one, thus obtaining an even distribution of the braking force between the first and second pads 5, 6. Specifically, if one of the two brake pads 5, 6 abuts against the brake disc 4 before the other one, the translation of the actuation shaft 7 with respect to the housing body 3, achievable by means of the floating connection elements 24, also allows the other pad to abut against the brake disc 4.

According to an embodiment, the floating connection elements 24 are further configured to realign the actuation shaft 7 in a predefined starting position thereof at an actuation of the first and second pads 5, 6.

According to an embodiment, the floating connection elements 24 comprises elastic devices.

According to an embodiment, the floating connection elements 24 comprise compression springs 25.

According to a preferred embodiment, the floating connection elements 24 are compression disc springs 25.

The compression springs 25 are configured to allow for a relative translation of the actuation shaft 7 with respect to the housing body 3 along the shaft axis 23, while providing elastic resistance to the relative translation of the actuation shaft 7 with respect to the housing body 3 along the shaft axis 23, so as to balance the positioning of the actuation shaft 7 with respect to the housing body 3.

According to an embodiment, the floating connection elements 24 comprise compression coil springs and/or squared springs and/or torsion springs and/or band springs and/or shaped springs.

According to an embodiment, the floating connection elements 24 comprise dampers 26.

The dampers 26 are configured to allow for a relative translation of the actuation shaft 7 with respect to the housing body 3 along the shaft axis 23, while damping the relative translation of the actuation shaft 7 with respect to the housing body 3 along the shaft axis 23, so as to balance the positioning of the actuation shaft 7 with respect to the housing body 3.

Preferably, the dampers 26 are polymeric dampers, e.g., made of rubber. According to an embodiment, the dampers 26 are configured both to damp the relative translation of the actuation shaft 7 with respect to the housing body 3 along the shaft axis 23 and to provide elastic resistance to the relative translation of the actuation shaft 7 with respect to housing body 3 along the shaft axis 23.

According to an embodiment, the floating connection elements 24 are ring-shaped elements 28 made of elastomeric material. The ring-shaped elements 28 made of elastomeric material are configured to allow for a relative translation of the actuation shaft 7 with respect to the housing body 3 along the shaft axis 23, while damping the relative translation of the actuation shaft 7 with respect to the housing body 3 along the shaft axis 23, so as to balance the positioning of the actuation shaft 7 with respect to the housing body 3.

According to an embodiment, the ends of the actuation shaft 7 are inserted into the respective ring-shaped elements 28 made of elastomeric material.

According to an embodiment, the actuation shaft 7 extends between two opposite ends of the actuation shaft 7, and the floating connection elements 24 are placed to be interposed between the housing body 3 and a respective end of the actuation shaft 7.

According to an embodiment, the housing body 3 defines two opposite housing seats 27 at the ends of the actuation shaft 7.

According to this embodiment, the ends of the actuation shaft 7 are housed in the housing seats 27.

According to an embodiment, the floating connection elements 24 are also housed in the housing seats 27.

According to an embodiment, the transmission system 9 is of the mechanical type.

According to an embodiment, the transmission system 9 comprises a gear 29 comprising a plurality of toothed wheels.

According to an embodiment, the gear 29 comprises a spur gear 30.

The spur gear 30 is connected to the actuation shaft 7.

Moreover, the spur gear 30 is configured to transmit a mechanical power generated by the electric motor 8 to the actuation shaft 7.

Advantageously, the spur gear 30 allows transmitting mechanical power to the actuation shaft 7 while allowing a relative translation in the direction of the shaft axis 23 between the actuation shaft 7 and the actuation system 9.

According to an embodiment, the spur gear 31 is fixed to be integral with the actuation shaft 7, coaxial to the shaft axis 23.

According to this embodiment, the spur gear 30 is configured to transmit mechanical power to the actuation shaft 7 and is simultaneously configured to be translatable with respect to the rest of the gear 29 in a direction parallel to the shaft axis 23.

According to the embodiment in which the floating connection elements 24 are ring-shaped elements 28 made of elastomeric material, the brake caliper 1 is configured so that the dynamic friction between the actuation shaft 7 and the ring-shaped elements 28 made of elastomeric material is less than the dynamic friction between the spur gear 30 and the rest of the gear 29. Therefore, the slip resistance of the actuation shaft 7 through the ring-shaped elements 28 made of elastomeric material is less than the slip resistance between the spur gear 30 and the rest of the gear 29. Advantageously, such a configuration ensures the actual receding of the pads 5, 6 from the brake disc 4 when the electric motor 8 is operated so that the pads 5, 6 are moved back with respect to the brake disc 4, thus avoiding one of the pads 5, 6 from remaining in contact with the brake disc 4.

According to an embodiment, the actuation shaft 7 comprises circumferential spur gear teeth.

According to this embodiment, the circumferential spur gear teeth are engaged with the spur gear 30 of the gear 29.

Advantageously, the spur gear 30 allows transmitting mechanical power to the actuation shaft 7 while allowing a relative translation in the direction of the shaft axis 23 between the actuation shaft 7 and the spur gear 30.

According to an embodiment, the spur gear 30 is placed at one end of the actuation shaft 7.

According to an embodiment, the spur gear 30 is placed opposite to the first threaded wall 12, with respect to the second threaded wall 33.

Advantageously, such a configuration reduces the overall dimensions of the brake caliper 1.

According to an embodiment, the housing body 3 comprises a support portion 31.

The support portion 31 is connected to the actuation shaft 7.

The support portion 31 is configured to support the actuation shaft 7, so as to prevent a translation of the actuation shaft 7 in a direction transverse to the shaft axis 23, yet allow for a rotation of the actuation shaft 7 about the shaft axis 23.

Advantageously, the support portion 31 contributes to supporting the stresses to which the actuation shaft 7 is subjected during the operation of the transmission system 9.

According to an embodiment, the support portion 31 is placed at a middle portion of the actuation shaft 7 between the first thread 19 and the second thread 21.

According to a preferred embodiment, the support portion 31 is placed substantially at the centerline of the actuation shaft 7.

Advantageously, such a configuration limits any displacement of the actuation shaft 7 in the direction transverse to the shaft axis 23 during the actuation of the transmission system 9.

According to an embodiment, the support portion 31 comprises a through hole extending along a direction parallel to the shaft axis 23.

The actuation shaft 7 is placed to pass through the through-hole of the support portion 31.

According to an embodiment, the brake caliper 1 comprises a plurality of linear guides 32.

The linear guides 32 are interposed between the housing body 3 and the first pad 5 or the second pad 6, respectively.

The linear guides 32 are configured to drive the approaching or receding movement of the first pad 5 and the second pad 6 with respect to the brake disc 4.

Advantageously, the linear guides 32 allow obtaining a greater control over the movement of the first and second pads 5, 6.

According to an embodiment, the linear guides 32 are connected to the first and second pads 5, 6 at a pushing portion 13 of the first and second pads 5, 6.

According to an embodiment, the linear guides 23 extend along directions parallel to the shaft axis 23.

Advantageously, such a configuration reduces the stresses and bending moment acting on the actuation shaft 7 and the first and second actuation devices 10, 11 during the actuation of the brake caliper 1.

Specifically, the bending moment acting on the actuation shaft 7 and on the first and second actuation devices 10, 11 is given by the actuation force of each pad 5, 6 directed along the shaft axis 23 and by the corresponding reaction force applied by the brake disc 4 to each pad 5, 6 and directed in a direction parallel to, but not coincident with, the shaft axis 23.

According to an embodiment, the brake caliper 1 comprises a plurality of hydraulic pistons 36.

The hydraulic pistons 36 are interposed between the housing body 3 and the first pad 5 or the second pad 6, respectively.

The hydraulic pistons 36 are configured to abut against the first and second pads 5, 6, respectively, so as to apply a braking force to the brake disc 4. Preferably, the hydraulic pistons 36 are actuated by means of a hydraulic actuation system outside the brake caliper 1.

Advantageously, the hydraulic pistons 36 are configured to perform a service braking.

According to this embodiment, the first and second screw-nut screw assemblies 34, 35 are used to perform a parking braking, and the hydraulic pistons 36 are used to perform a service braking.

According to an embodiment, the hydraulic pistons 36 are connected to the first and second pads 5, 6 at a pushing portion 13 of the first and second pads 5, 6.

According to a further aspect of the invention, a disc brake 2 comprises a brake caliper 1 as described above. According to an embodiment, the disc brake 2 further comprises a brake disc 4 interposed between the two pads 5, 6 of the brake caliper 1.

According to an embodiment, the disc brake 2 is configured to perform a service braking.

According to this embodiment, the first actuation device 10 and the second actuation device 11 of the brake caliper 1 of the disc brake 2 are a first recirculating-ball screw 17 and a second recirculating-ball screw 18, respectively.

The first recirculating-ball screw 17 and the second recirculating-ball screw 18 are configured to perform a service braking.

According to an embodiment, the first recirculating-ball screw 17 and the second recirculating-ball screw 18 have a reversible-type thread.

According to an embodiment, the disc brake 2 is configured to perform a parking braking.

According to this embodiment, the first actuation device 10 and the second actuation device 11 of the brake caliper 1 of the disc brake 2 are a first screw-nut screw assembly 34 and a second screw-nut screw assembly 35, respectively.

The first screw-nut screw assembly 34 and the second screw-nut screw assembly 35 are configured to perform a parking braking.

According to an embodiment, the first screw-nut screw assembly 34 and the second screw-nut screw assembly 35 have an irreversible-type thread.

According to an embodiment, the brake caliper 2 further comprises a plurality of hydraulic pistons 36.

The plurality of hydraulic pistons 36 is configured to perform a service braking.

Advantageously, the disc brake 2 thus configured is particularly suitable for light vehicles, such as electric city-cars and robotaxis, for example.

Advantageously, a brake caliper 1 and a disc brake 2 thus configured allow for an elimination of the residual torque otherwise acting on the brake disc 4. Such an elimination further results in a reduction in the energy dissipated when not required, and a reduction in the pad wear and in the resulting particulate emission.

With added advantage, the elimination of residual torque allows saving on the cost of the batteries for BEVs with the same mileage range.

With added advantage, a brake caliper 1 and a disc brake 2 so configured have small axial dimensions, i.e., small dimensions along the shaft axis 23.

With added advantage, such a configuration of the brake caliper 1 of the disc brake 2 allows making the appearance thereof similar to that of conventional hydraulic calipers.

Obviously, those skilled in the art will be able to make changes or adaptations to the present invention, without however departing from the scope of the following claims.

### List of Reference Numerals

1. Brake caliper
2. Disc brake
3. Housing body
4. Brake disc
5. First pad
6. Second pad
7. Actuation shaft
8. Electric motor
9. Transmission system
10. First actuation device
11. Second actuation device
12. First threaded wall
13. Pushing portion
14. Connecting portion
15. Friction material layer
16. Support plate
17. First recirculating-ball screw
18. Second recirculating-ball screw
19. First thread
20. First nut screw
21. Second thread
22. Second nut screw
23. Shaft axis
24. Floating connection elements
25. Compression springs
26. Dampers
27. Housing seats
28. Ring-shaped elements made of elastomeric material
29. Gear
30. Spur gear
31. Support portion
32. Linear guide
33. Second threaded wall
34. First screw-nut screw assembly
35. Second screw-nut screw assembly
36. Hydraulic pistons

1-16. (canceled)

17. A brake caliper (1) for a disc brake (2), comprising a housing body (3) suitable to be connected integral to a vehicle spindle, said brake caliper (1) comprising a first pad (5) and a second opposite pad (6) connected to the housing body (3),
wherein the first pad (5) and the second pad (6) are spaced apart and delimit a disc space to accommodate a brake disc (4),
wherein the brake caliper (1) comprises an electric motor (8) and a transmission system (9), and wherein the transmission system (9) is configured to transmit a mechanical power generated by the electric motor (8) to the first pad (5) and the second pad (6),
wherein the transmission system (9) comprises a first actuation device (10) and a second actuation device (11),
wherein the first actuation device (10) is placed at the first pad (5), and it is configured to actuate the first pad (5) approaching to or receding from the brake disc (4),
wherein the second actuation device (11) is placed at the second pad (6), and it is configured to actuate the second pad (6) approaching to or receding from the brake disc (4),
characterized in that the first actuation device (10) comprises a first threaded wall (12) forming a first thread (19),
the second actuation device (11) comprises a second threaded wall (33) forming a second thread (21),
and wherein the first thread (19) is opposite to the second thread (21).

18. The brake caliper (1) according to claim 17, wherein the first thread (19) is a right-hand thread, and the second thread (21) is a left-hand thread.

19. The brake caliper (1) according to claim 17, wherein the first actuation device (10) is connected integral to the first pad (5), and the second actuation device (11) is connected integral to the second pad (6),
and preferably, the first actuation device (10) comprises a first nut screw (20) connected integral to the first pad (5) and the second actuation device (11) comprises a second nut screw (22) connected integral to the second pad (6).

20. The brake caliper (1) according to claim 17, wherein the first actuation device (10) comprises a first recirculating-ball screw (17), and the second actuation device (11) comprises a second recirculating-ball screw (18),
wherein the first recirculating-ball screw (17) comprises a first nut screw (20) externally connected to the first threaded wall (12), and the second recirculating-ball screw (18) comprises a second nut screw (22) externally connected to the second threaded wall (33),
and wherein the first recirculating-ball screw (17) has a right-hand thread, and the second recirculating-ball screw (18) has a left-hand thread,
and preferably, both the first recirculating-ball screw (17) and the second recirculating-ball screw (18) have a reversible-type thread.

21. The brake caliper (1) according to claim 17, wherein the first actuation device (10) comprises a first screw-nut screw assembly (34), and the second actuation device (11) comprises a second screw-nut screw assembly (35),
wherein the first screw-nut screw assembly (34) comprises a first nut screw (20) externally connected to the first threaded wall (12), and the second screw-nut screw assembly (35) comprises a second nut screw (22) externally connected to the second threaded wall (33),
and wherein the first screw-nut screw assembly (34) has a right-hand thread, and the second screw-nut screw assembly (35) has a left-hand thread,
and preferably, both the first screw-nut screw assembly (34) and the second screw-nut screw assembly (35) have an irreversible-type thread.

22. The brake caliper (1) according to claim 17, wherein the transmission system (9) comprises a threaded actuation shaft (7),
wherein the actuation shaft (7) comprises the first threaded wall (12) and the second threaded wall (33) forming the first right-hand thread (19) and the second left-hand thread (21), respectively,
wherein both the first pad (5) and the second pad (6) are connected to the actuation shaft (7),
and wherein the actuation shaft (7) is configured to move both the first pad (5) and the second pad (6) approaching to or receding from the brake disc (4),
and preferably, the first pad (5) is connected to the actuation shaft (7) at the first thread (19), and the second pad (6) is connected to the actuation shaft (7) at the second thread (21).

23. The brake caliper (1) according to claim 17, wherein each of the first pad (5) and second pad (6) comprises a pushing portion (13) and a connecting portion (14),
wherein the pushing portion (13) is placed at the brake disc (4) and comprises a friction material layer (15) facing the brake disc (4), and a support plate (16) supporting the friction material layer (15),
wherein the first pad (5) and the second pad (6) are connected to the transmission system (9) at their own respective connecting portion (14),
wherein the first actuation device (10) is placed at the connecting portion (14) of the first pad (5), and the second actuation device (11) is placed at the connecting portion (14) of the second pad (6).

24. The brake caliper (1) according to claim 22, wherein the actuation shaft (7) is extended along a shaft axis (23) extended in a direction parallel to the rotation axis of the brake disc (4) and not passing through the brake disc (4),
wherein the actuation shaft (7) is connected to the housing body (3) by floating connection elements (24),
wherein the floating connection elements (24) are configured to allow for a relative translation between the actuation shaft (7) and the housing body (3) in the direction of the shaft axis (23).

25. The brake caliper (1) according to claim 24, wherein the floating connection elements (24) comprise elastic devices,
and/or the floating connection elements (24) comprise compression springs (25),
and/or the floating connection elements (24) are compression disk springs (25),
and/or the floating connection elements (24) comprise compression coil springs and/or squared springs and/or torsion springs and/or band springs and/or shaped springs,
and/or the floating connection elements (24) comprise some dampers (26),
and/or the floating connection elements (24) comprise polymeric dampers, e.g., made of rubber,
and/or the floating connection elements (24) comprise ring-shaped elements made of elastomeric material (28),
and/or wherein the actuation shaft (7) is extended between two opposite actuation shaft (7) ends, and the floating connection elements (24) are placed interposed between the housing body (3) and one respective actuation shaft (7) end,
and/or wherein the housing body (3) defines two opposite housing seats (27) at the actuation shaft (7) ends, and wherein the actuation shaft (7) ends are accommodated in the housing seats (27), and wherein the floating connection elements (24) are accommodated inside the housing seats (27).

26. The brake caliper (1) according to claim 22, wherein the transmission system (9) comprises a gear (29) comprising a plurality of cogwheels,
wherein the gear (29) comprises a spur gear (30) connected to the actuation shaft (7), wherein the spur gear (30) is configured to transmit a mechanical power generated by the electric motor (8) to the actuation shaft (7),
and wherein the spur gear (31) is fixed integral to the actuation shaft (7), coaxial to the shaft axis (23), and the spur gear (30) is configured to transmit mechanical power to the actuation shaft (7) and at the same time is configured to be movable relatively to the rest of the gear (29) in a direction parallel to the shaft axis (23),
or wherein the actuation shaft (7) comprises circumferential spur gear teeth, and the circumferential spur gear teeth are engaged to the spur gear (30) of the gear (29),
and preferably, the spur gear (30) is placed at an actuation shaft (7) end opposite to the first threaded wall (12) with respect to the second threaded wall (33).

27. The brake caliper (1) according to claim 22, wherein the housing body (3) comprises a support portion (31),
wherein the support portion (31) is connected to the actuation shaft (7), and it is configured to support the actuation shaft (7), in such a way to prevent a translation of the actuation shaft (7) in a direction transversal to the shaft axis (23), yet allow for a rotation of the actuation shaft (7) about the shaft axis (23),
and preferably, the support portion (31) is placed at a middle portion of the actuation shaft (7) between the first thread (19) and the second thread (21),
and preferably, the support portion (31) comprises a through-hole extended along a direction parallel to the shaft axis (23), and wherein the actuation shaft (7) is placed as passing through the through-hole of the support portion (31).

28. The brake caliper (1) according to claim 17, comprising a plurality of linear guides (32) interposed between the housing body (3) and the first pad (5) or the second pad (6), respectively,
wherein the linear guides (32) are configured to drive the approaching or receding movement of the first pad (5) and the second pad (6) with respect to the brake disc (4),
and preferably, the linear guides (32) are connected to the first and the second pads (5, 6) at a pushing portion (13) of the first and the second pads (5, 6).

29. The brake caliper (1) according to claim 17, comprising a plurality of hydraulic pistons (36) interposed between the housing body (3) and the first pad (5) or the second pad (6), respectively,
wherein the hydraulic pistons (36) are configured to abut against the first and the second pads (5, 6), respectively, in such a way to perform a braking force on the brake disc (4),
and preferably, the hydraulic pistons (36) are connected to the first and the second pads (5, 6) at a pushing portion (13) of the first and the second pads (5, 6).

30. A disc brake (2) comprising a brake caliper (1) according to claim 17.

31. The disc brake (2) according to claim 30, configured to perform a service braking,
wherein the first actuation device (10) and the second actuation device (11) of the brake caliper (1) of the disc brake (2) are a first recirculating-ball screw (17) and a second recirculating-ball screw (18), respectively,
and wherein the first recirculating-ball screw (17) and the second recirculating-ball screw (18) are configured to perform a service braking,
and preferably, the first recirculating-ball screw (17) and the second recirculating-ball screw (18) have a reversible-type thread.

32. The disc brake (2) according to claim 30, configured to perform a parking braking,
wherein the first actuation device (10) and the second actuation device (11) of the brake caliper (1) of the disc brake (2) are a first screw-nut screw assembly (34) and a second screw-nut screw assembly (35), respectively,
and wherein the first screw-nut screw assembly (34) and the second screw-nut screw assembly (35) are configured to perform a parking braking,
and preferably, the first screw-nut screw assembly (34) and the second screw-nut screw assembly (35) have an irreversible-type thread,
and optionally, the disc brake (2) further comprises a plurality of hydraulic pistons (36) configured to perform a service braking.
